(19) United States
(12) Patent Application Publication
(10) Pub. No.: US 2003/0138036 A1
(43) Pub. Date: Jul. 24, 2003

(54) Method and device for identifying bit rate using frequency divider

(76) Inventors: Kwang-Jin Yang, Yongin-shi (KR); Do-Ik Kim, Yongin-shi (KR)

Correspondence Address: CHA & REITER, 411 HACKENSACK AVE, 9TH FLOOR, HACKENSACK, NJ, 07601, US

(21) Appl. No.: 10/334,237

(22) Filed: Dec. 31, 2002

(30) Foreign Application Priority Data
Jan. 24, 2002 (KR) 2002-4119

(51) Int. Cl. H04Q 1/20; H04B 3/46

(52) U.S. Cl. 375/225

(57) ABSTRACT

A device for identifying a bit rate includes: a first frequency divider for primarily dividing an inputted electrical signal at a previously set ratio of 1:R₁; a second frequency divider for secondarily dividing the primarily divided electrical signal at a previously set ratio of 1:R₂; and, a controller for calculating a frequency from the number of pulses of the secondarily divided electrical signal and then identifying a bit rate corresponding to the frequency.

### CLAIM OF PRIORITY

This application claims priority to an application entitled “METHOD AND DEVICE FOR IDENTIFYING BIT RATE USING FREQUENCY DIVIDER,” filed in the Korean Industrial Property Office on Jan. 24, 2002 and assigned Serial No. 2002-4119, the contents of which are hereby incorporated by reference.

### BACKGROUND OF THE INVENTION

1. Field of the Invention

The present invention relates to an optical-communication system and, more particularly, to a device for identifying a bit rate of received signals.

2. Description of the Related Art

Various protocols and bit rates are adopted in an optical-communication system. For example, there are bit rates of 125 Mb/s, 155.520 Mb/s, 200 Mb/s, 622.080 Mb/s, 1062.500 Mb/s, 1.25 Gb/s, 2488.320 Mb/s, etc. in an FDDI (Fiber Distributed Data Interface), ESCON (Enterprise Systems CONnectivity), fiber channel, gigabit Ethernet, ATM (Asynchronous Transfer Mode), etc. As described above, a bit rate according to one of the protocols can be selected and adopted in a corresponding optical-communication system. To this end, a bit-rate identification device is provided to secure an appropriate transmission format and to adapt the bit-rate variation according to the transmission format—i.e., transparency.

FIG. 1 is a block diagram illustrating a conventional bit-rate identification device, which includes a buffer 110, a delay unit 120, an operator 130, a filter 140, an A/D (Analog/Digital) converter 150, and a processor 160.

In operation, the buffer 110 divides an incoming electrical signal into two electrical signals. The delay unit 120 delays one of the divided electrical signals by a predetermined period of time and then outputs the delayed electrical signal. The operator 130 carries out a logical operation EXOR (EXclusive OR) on the two received electrical signals including the delayed electrical signal, then outputs the result of the logical operation EXOR in the form of an electrical signal made up of a predetermined number of pulses.

The filter 140 performs a low-pass filtering on the electrical output signal from the operator 130 and then outputs a low-pass filtered signal. The A/D converter 150 converts the low-pass filtered signal into a digital signal and outputs the digital signal. As the voltage level of the low-pass filtered signal linearly and proportionally increases to a bit rate, the processor 160 can identify the bit rate from the voltage level of the low-pass filtered signal.

However, there are drawbacks with the conventional bit-rate detector. For example, the delay unit 120 must have a steady delay output, but the delay characteristics tend to vary with environmental factors, such as temperature variation. In addition, a waveform shaping of an input signal, which is difficult to perform, is needed in an analog circuit.

### SUMMARY OF THE INVENTION

Therefore, the present invention has been made to overcome the above problems and provides additional advantages by providing a digitalized bit-rate identification device that is immune to a temperature variation.

In accordance with one aspect of the present invention, a device for identifying a bit rate includes: a first frequency divider for primarily dividing an inputted electrical signal at a previously set ratio of 1:R₁; a second frequency divider for secondarily dividing the primarily divided electrical signal at a previously set ratio of 1:R₂; and, a controller for calculating the frequency from the number of pulses of the secondarily divided electrical signal and then identifying a bit rate corresponding to the frequency.

In accordance with another aspect of the present invention, there is provided a method for identifying a bit rate, comprising the steps of: (a) dividing an inputted electrical signal at a previously set ratio of 1:R; (b) counting the number of pulses of the divided electrical signal for a predetermined time period; (c) calculating the frequency of the electrical signal using the equation of F=N×T×R, where F represents the frequency of the electrical signal, N represents the counted number of pulses, and T represents the time period for which the number of pulses is counted; and, (d) identifying the bit rate corresponding to the calculated frequency.

### BRIEF DESCRIPTION OF THE DRAWINGS

The above features and other advantages of the present invention will be more clearly understood from the following detailed description taken in conjunction with the accompanying drawings, in which:

FIG. 1 is a block diagram illustrating a conventional bit-rate identification device;

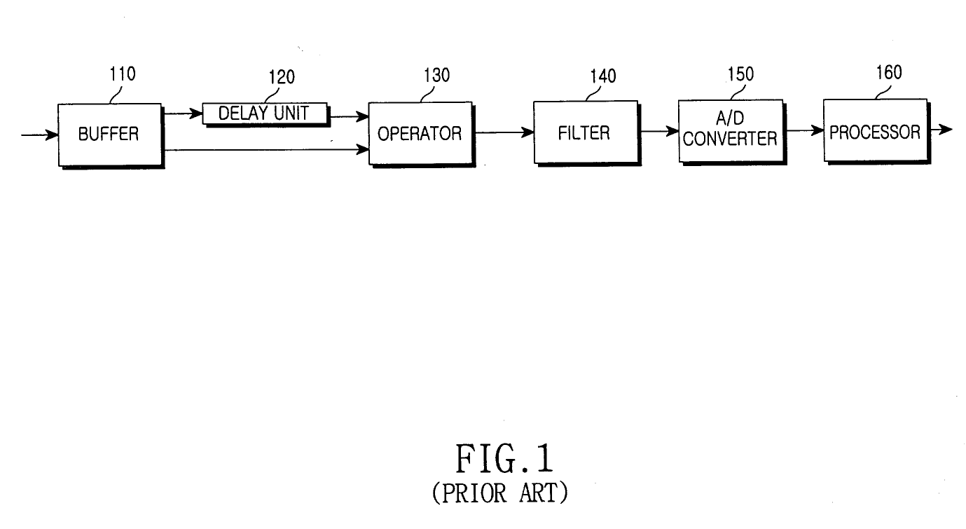

FIG. 2 is a block diagram illustrating a reception end of the optical-communication system in accordance with an embodiment of the present invention;

FIG. 3 is a block diagram illustrating a bit-rate identification device shown in FIG. 2;

FIG. 4 is a graph illustrating a relationship between the bit rate and the number of pulses associated with the bit-rate identification device shown in FIG. 3; and,

FIG. 5 is a flow chart illustrating a bit-rate identification method in accordance with an embodiment of the present invention.

### DETAILED DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted as it may make the subject matter of the present invention unclear.

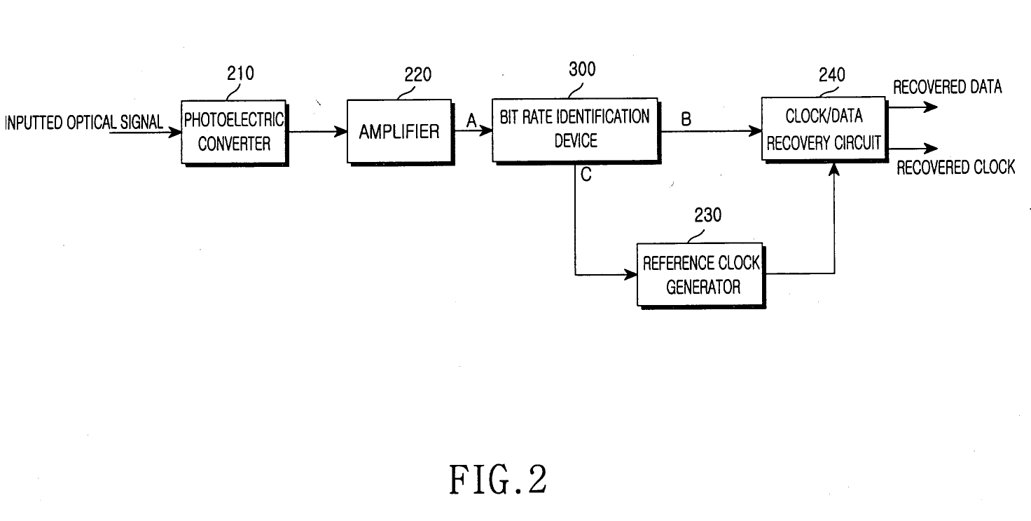

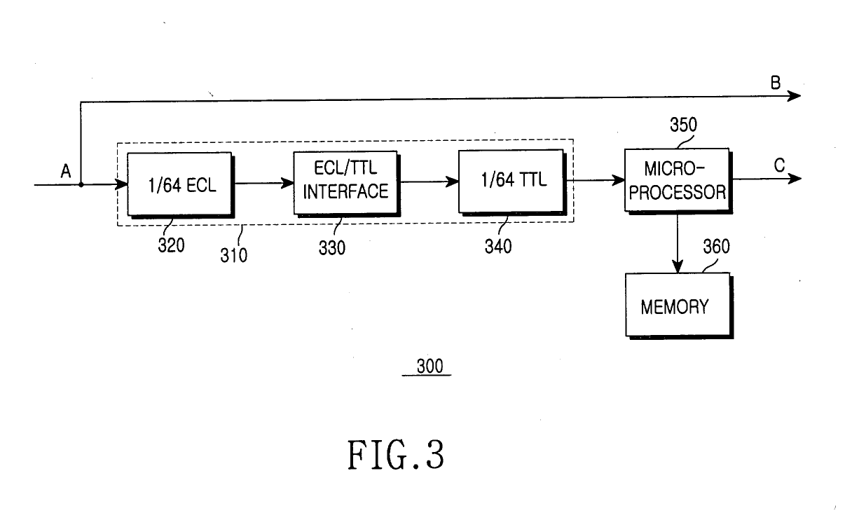

FIG. 2 is a block diagram illustrating a reception side of the optical-communication system in accordance with an embodiment of the present invention, and FIG. 3 is a block diagram illustrating the bit-rate identification device shown in FIG. 2. As explained later, the reception end of the optical-communication system according to the embodiment of the present invention is operable in response to an optical signal inputted at any bit rate.

The inventive optical-reception system includes a photoelectric converter 210, an amplifier 220, a bit-rate identification device 300, a reference-clock generator 230, and a clock/data recovery circuit 240.

The photoelectric converter 210 converts an optical signal inputted at a given bit rate into an electrical signal and then outputs the electrical signal. A photodiode can be employed as the photoelectric converter 210.

The amplifier 220 amplifies the received electrical signal and then outputs the amplified electrical signal to the bit-rate identification device 300. The amplifier 220 includes a pre-amplifier for amplifying the electrical signal at a predetermined ratio and a limiter for re-amplifying the amplified electrical signal within a previously set voltage level, wherein the pre-amplifier and the limiter are connected in series.

Referring to FIG. 3, the bit-rate identification device 300 includes a frequency divider 310, a microprocessor 350, and a memory 360. The frequency divider 310 includes a 1/64 ECL (Emitter-Coupled Logic) 320, an ECL/TTL (Transistor Transistor Logic) interface 330, and a 1/64 TTL 340. The 1/64 ECL 320 primarily divides the amplified electrical signal at a previously set ratio of 1:R₁ (=64) and comprises a logic circuit having a differential amplifier commonly connected between the emitters of two transistors. The ECL 320 has a high operating rate and is referred to as CML (Current Mode Logic). As the frequency of 1.25 GHz is out of the operating frequency range of the microprocessor 350 where the maximum frequency of an electrical signal inputted in the 1/64 ECL 320 is 1.25 GHz, the 1/64 ECL 320 uses a frequency of 4 GHz, which is maximally operable in the microprocessor 350.

The ECL/TTL interface 330 converts an ECL voltage level of the divided electrical signal into a TTL voltage level. Because the voltage levels of the ECL 320 and the TTL 340 are different, the ECL/TTL interface 330 is needed between the ECL 320 and the TTL 340.

The 1/64 TTL 340 secondarily divides the divided electrical signal at a previously set ratio of 1:R₂ (=64) and comprises a saturation-logic circuit in which the logic gate of a multi-emitter transistor and a transistor output circuit are combined.

The microprocessor 350 has a 16-bit counter (not shown) embedded therein and counts the number of pulses of the secondarily divided electrical signal for a predetermined time period (=T). The microprocessor 350 calculates the frequency from the counted pulses and then identifies a bit rate corresponding to the calculated frequency. The microprocessor 350 calculates the frequency using the following Equation 1.

F=N×T×(R₁×R₂) Equation 1

In Equation 1, F represents the frequency of the electrical signal, N represents the number of pulses counted, and T represents the time period during which the number of pulses is counted.

Using the configuration described above, the bit-rate identification device 300 is capable of calculating the frequency independent of the waveform of an electrical signal inputted in the bit-rate identification device 300. The 16-bit counter embedded in the microprocessor 350 theoretically secures a precision of 0.0015% (½¹⁶) for a full scale, and the calculation error depends on the number of bits in the counter (resolution) and the precision of a counting time. Here, the microprocessor 350 can improve the calculation precision to fall within 0.01% using a precision-crystal oscillator (X-TAL). An exemplary microprocessor that can be employed is an ADuC812 chip manufactured by Analog Devices, Inc.

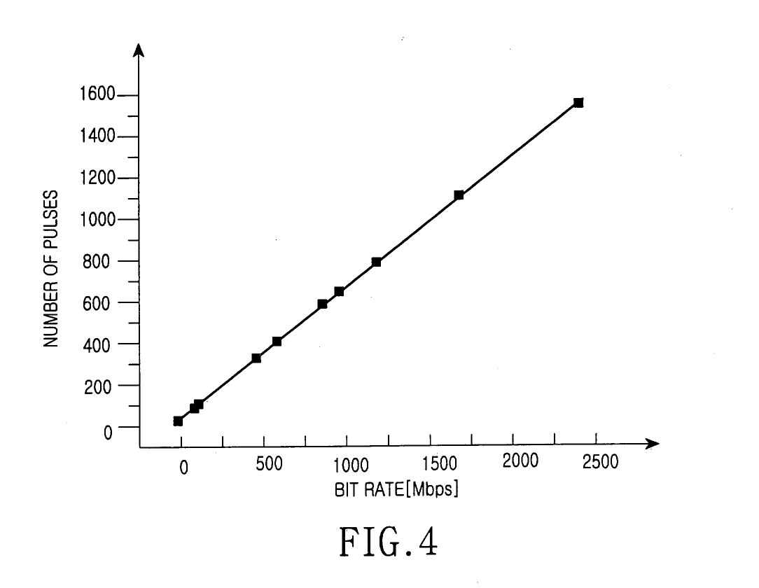

FIG. 4 is a graph illustrating the relationship between the bit rate and the number of pulses associated with the bit-rate identification device 300 shown in FIG. 3 where the counting time of the microprocessor 350 is 10 ms. As shown in FIG. 4, the bit rate is linearly proportional to the counted number of pulses counted.

The memory 360 stores a look-up table such as the following Table 1 so that the microprocessor 350 can read the bit rate corresponding to the calculated frequency.

TABLE 1

| Bit rate [Mbps] | Counted number of pulses |
|---|---|
| 51.84 | 31 or 32 |
| 125 | 76 or 77 |
| 155.52 | 94 or 95 |
| 446.56 | 284 or 285 |
| 622.08 | 379 or 380 |
| 933.12 | 569 or 570 |
| 1062.5 | 648 or 649 |
| 1244.16 | 759 or 760 |
| 1250 | 762 or 763 |
| 1866.24 | 1139 or 1140 |
| 2488.32 | 1518 or 1519 |

Referring back to FIG. 2, the reference-clock generator 230 includes a plurality of oscillators for generating clock signals with different frequencies. The reference-clock generator 230 selectively operates an internal oscillator to generate a reference clock of the same as the bit rate, which is identified by the microprocessor 350.

The clock/data recovery circuit 240 recovers the clock and data of the electrical signal inputted from the amplifier 220 according to the reference clock generated from the reference-clock generator 230. Then, the clock/data recovery circuit 240 recovers the clock and data of the electrical signal by reshaping, regenerating, and re-timing the electrical signal according to the reference clock generated from the reference-clock generator 230.

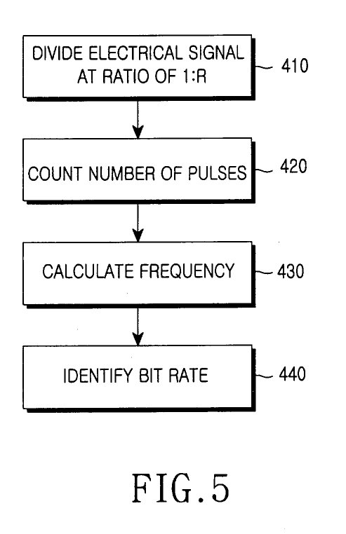

FIG. 5 is a flow chart illustrating the bit-rate identification method in accordance with an embodiment of the present invention. The bit-rate identification method includes a dividing step 410, a counting step 420, a calculating step 430, and a bit-rate identifying step 440.

In step 410, an electrical signal inputted in the bit-rate identification device 300 is divided at a ratio of 1:R using the 1/64 ECL 320, the ECL/TTL interface 330, and the 1/64 TTL 340, wherein R is the product of R₁ by R₂.

In step 420, the counter embedded in the microprocessor 350 counts the number of pulses in the divided electrical signal for a predetermined time period (=T).

In step 430, the microprocessor 350 calculates the frequency of the electrical signal using the following Equation 2.

F=N×T×R Equation 2

In Equation 2, F represents the frequency of the electrical signal, N represents the counted number of pulses, and T represents the time period during which the number of pulses is counted.

In step 440, the microprocessor 350 identifies a bit rate corresponding to the calculated frequency using the look-up table stored in the memory 360.

As apparent from the above-description, the present invention provides a method and device for identifying a bit rate using a frequency-dividing scheme. The bit-rate identification device of the present invention is made up of digital circuit components. The inventive bit-rate identification device can remove an error caused by different operation characteristics of homogeneous components and temperature variations in the conventional analog circuit. As such, no special adjustment is needed during the mass production of bit-rate identification devices. Moreover, unlike the prior art bit-rate identification, the present invention does not need to perform the impedance matching of a precision substrate nor perform a complicated calculation of the delay time because the frequency is calculated independent of the waveform of an electrical signal inputted in the bit-rate identification device. Furthermore, the number of components and cost of manufacturing can be reduced as the ECL's operating frequency is over 1.25 GHz.

Although the preferred embodiments of the present invention have been disclosed for illustrative purposes, those skilled in the art will appreciate that various modifications, additions, and substitutions are possible, without departing from the scope of the invention. Therefore, the present invention is not limited to the above-described embodiments, but the present invention is defined by the claims, which follow along with their full scope of equivalents.

What is claimed is:

1. A device for identifying a bit rate comprising:
a first frequency divider for primarily dividing an inputted electrical signal at a previously set ratio of 1:R₁;
a second frequency divider for secondarily dividing the primarily divided electrical signal at a previously set ratio of 1:R₂; and,
a controller for calculating the frequency from the number of pulses of the secondarily divided electrical signal and for identifying a bit rate based on the calculated frequency.

2. The device as set forth in claim 1, further comprising:
a voltage-level converter for converting the voltage level of the primarily divided electrical signal into a voltage level applicable to the second frequency divider.

3. The device as set forth in claim 1, wherein the controller calculates the frequency of the electrical signal using an equation of:
F=N×T×(R₁×R₂),
wherein F represents the frequency of the electrical signal, N represents the counted number of pulses, and T represents the time period for which the number of pulses is counted.

4. The device as set forth in claim 2, wherein the controller calculates the frequency of the electrical signal using the equation of:
F=N×T×(R₁×R₂),
wherein F represents the frequency of the electrical signal, N represents the counted number of pulses, and T represents the time period for which the number of pulses is counted.

5. A device for identifying a bit rate comprising:
an ECL (Emitter-Coupled Logic) for primarily dividing an inputted electrical signal at a previously set ratio of 1:R₁;
an ECL-TTL (Transistor Transistor Logic) interface for converting the ECL voltage level of the primarily divided electrical signal into a TTL voltage level;
a TTL for secondarily dividing the converted electrical signal at a previously set ratio of 1:R₂; and,
a microprocessor for calculating the frequency from the number of pulses of the secondarily divided electrical signal and for identifying a bit rate based on the calculated frequency.

6. The device as set forth in claim 5, wherein the microprocessor calculates the frequency of the electrical signal using the equation of:
F=N×T×(R₁×R₂),
wherein F represents the frequency of the electrical signal, N represents the counted number of pulses, and T represents the time period for which the number of pulses is counted.

7. A method for identifying a bit rate, comprising the steps of:
a) dividing an inputted electrical signal at a previously set ratio of 1:R;
b) counting the number of pulses of the divided electrical signal for a predetermined time period;
c) calculating the frequency of the electrical signal using the equation of F=N×T×R, wherein F represents the frequency of the electrical signal, N represents the counted number of pulses, and T represents the time period for which the number of pulses is counted; and,
d) identifying a bit rate based on the calculated frequency.
